(19) United States
(12) Patent Application Publication
(10) Pub. No.: US 2010/0204923 A1
(43) Pub. Date: Aug. 12, 2010

(54) Comparing Accuracies Of Lie Detection Methods

(76) Inventor: Bruce Alan White, Houston, TX (US)

Correspondence Address: Law Offices of Tim Headley, 7941 Katy Fwy, Suite 506, Houston, TX, 77024-1924, US

(21) Appl. No.: 12/702,598

(22) Filed: Feb. 9, 2010

Related U.S. Application Data
(60) Provisional application No. 61/151,253, filed on Feb. 10, 2009.

(51) Int. Cl. G06F 17/18; G06F 19/00; G06N 5/02

(52) U.S. Cl. 702/19; 702/179; 706/48

(57) ABSTRACT

A method for selecting the most accurate lie detection method from a group of methods, the method includes the steps of: (a) collecting the results from different methods of conducting lie detection tests; (b) plotting the results on a polar graph; c) computing the “random chance” point on the graph for each method's results; (d) fitting a quadratic curve to the defined points for each method; (e) computing the area beneath each method's curve; (f) mapping the area to a log-base-2 score; and (g) choosing as the most accurate method the method with a higher log-base-2 score.

### CROSS-REFERENCES TO RELATED APPLICATIONS

This patent application claims the benefit of provisional patent application no. 61/151,253, filed on Feb. 10, 2009, which is incorporated by reference in its entirety.

### STATEMENT REGARDING FEDERALLY SPONSORED RESEARCH OR DEVELOPMENT

None.

### REFERENCE TO A “SEQUENCE LISTING,” A TABLE, OR A COMPUTER PROGRAM LISTING APPENDIX SUBMITTED ON A COMPACT DISC AND AN INCORPORATION BY REFERENCE OF THE MATERIAL ON THE COMPACT DISC

None.

### BACKGROUND OF THE INVENTION

(1) Field of the Invention

This invention relates generally to lie detection methods.

(2) Description of the Related Art

U.S. Pat. No. 5,327,899, which is incorporated by reference in its entirety, discloses a method of using a logistic regression model to convert an 80th percentile of standardized relevant features into a probability of deception. This method first measures various physiological signals, including galvanic skin response, blood pressure, and respiration.

U.S. Pat. No. 7,565,193, which is incorporated by reference in its entirety, discloses a method of determining whether a subject is truthful or deceptive by, in part, measuring brain activity of the subject during questioning.

U.S. Patent Application No. 20040143170, which is incorporated by reference in its entirety, discloses a lie detection method which uses a virtual reality system presenting stimuli to the examinee, while measuring one or more of the following: electroencephalographic signals, electromyographic signals, electrooculographic signals, electrocardiographic signals, body position, motion and acceleration, vibration, skin conductance, respiration, and temperature.

However, potential examiners, such as in a police department, would like to know which of these various methods is the most accurate at a selected tolerance of inconclusive lie detection calls. Various methods exist for analyzing data, and discovering dependencies of groups of data. For example, U.S. Pat. No. 7,647,293, which is incorporated by reference in its entirety, discloses a method of discovering dependencies between relational database column pairs, and application of discoveries to query optimization.

A helpful technique in analyzing large amounts of data is to visualize the data. U.S. Pat. Nos. 5,541,854, 5,544,267, 5,995,114, 6,086,619, 6,356,256, 6,990,238, and 7,557,805, which are each incorporated by reference in its entirety, disclose various methods of visualizing large amounts of data.

Within the spectrum of analyzing data by visualization, some have used scatter plots to aid the visualization. U.S. Pat. No. 6,725,217, which is incorporated by reference in its entirety, discloses using a radial graph, and, in response to a user selecting a category, visually displaying matching elements in the category along with its nearest neighbor categories in a scatter plot. U.S. Pat. No. 7,330,823, which is incorporated by reference in its entirety, discloses a method of displaying sociometric analysis results in graphic displays such as scatterplot diagrams. U.S. Pat. No. 7,344,890, which is incorporated by reference in its entirety, discloses a method for discriminating platelets from red blood cells, using a scatterplot of an analyzed blood sample. Finally, U.S. Patent Application No. 20070258620, which is incorporated by reference in its entirety, discloses a method for visualization of directional statistics, including determining a spherical scatterplot of the volume of interest augmented with a cone graph for visualization of at least one of the directional classes, and displaying and/or storing the scatterplot.

All polygraph and other lie detection methodologies have three interdependent variables in measuring the correctness of any approach to detecting deception or truthfulness within a population of subjects. These accuracy variables are: percentage of correct calls, percentage of incorrect calls, and percentage of inclusive (or undetermined) calls. A historical problem in polygraph is that these accuracy variables are interrelated. Interrelated, with interdependent trade offs, that maximize one variable of accuracy, while reducing another. As one example, as inconclusives are reduced, then incorrect calls increase. This ambiguity as to how to measure the accuracy of a polygraph methodology upon a population, with a single overarching objective value, has limited polygraph researchers in comparing the accuracy of different approaches to analyzing polygraph data. Accuracy must be measurable before it can be improved. Accordingly, there is a need for an improved method of comparing the accuracies of various lie detection methods.

### BRIEF SUMMARY OF THE INVENTION

A method for selecting the most accurate lie detection method from a group of methods, the method includes the steps of: (a) collecting the results from different methods of conducting lie detection tests; (b) plotting the results on a polar graph; c) computing the “random chance” point on the graph for each method's results; (d) fitting a quadratic curve to the defined points for each method; (e) computing the area beneath each method's curve; (f) mapping the area to a log-base-2 score; and (g) choosing as the most accurate method the method with a higher log-base-2 score.

### BRIEF DESCRIPTION OF THE SEVERAL VIEWS OF THE DRAWINGS

FIG. 1 is a view of a basic visualization graph, being a section of a polar graph showing both polar coordinates and Cartesian coordinates.

FIG. 2 is a view of the visualization graph, showing specific points on the alpha curve.

FIG. 3 is a view of the visualization graph, showing the upper boundaries for white alpha points that generate general white alpha scores of 1, 2, and 3.

FIG. 4 is a view of the visualization graph, showing the points used to define general alpha value.

FIG. 5 is a current working white alpha accuracy graph.

FIGS. 6A-6D are visualizations of the comparison of the accuracies of two different lie detection methods.

FIG. 7A uses a scatterplot to depict the accuracy of a lie detection rule set for a particular lie detection methodology, at a fifteen percent inconclusive, and FIG. 7B is an enlargement of the part of FIG. 7A where the fifteen percent inconclusive intercepts the scatterplot.

FIGS. 8A and 8B illustrate the region A concept.

FIG. 9 shows the lie detection rule set that generated the selected general white alpha point.

FIG. 10 depicts a screen interface that allows a user to specify a set of rules for determining truthfulness.

FIG. 11 is a flow chart showing a method for evaluating a set of rules for determining truthfulness.

FIG. 12 shows a flow diagram for a general autoscore procedure.

FIG. 13 shows how an autoscore database is organized.

FIG. 14 shows a flow diagram for a progressive autoscore.

FIG. 15 shows how a progressive autoscore database is organized.

### DETAILED DESCRIPTION OF THE INVENTION

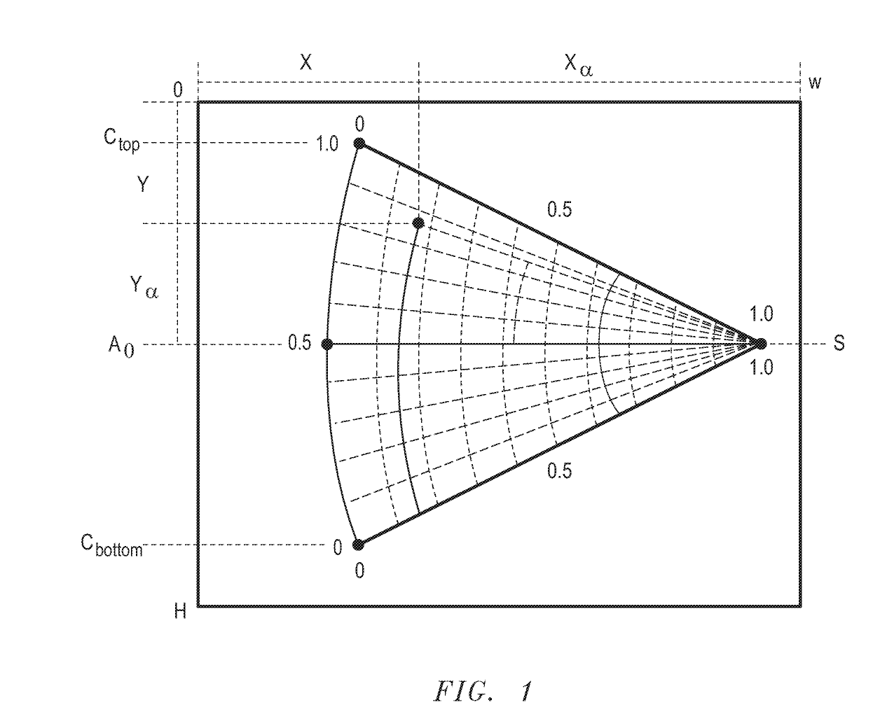

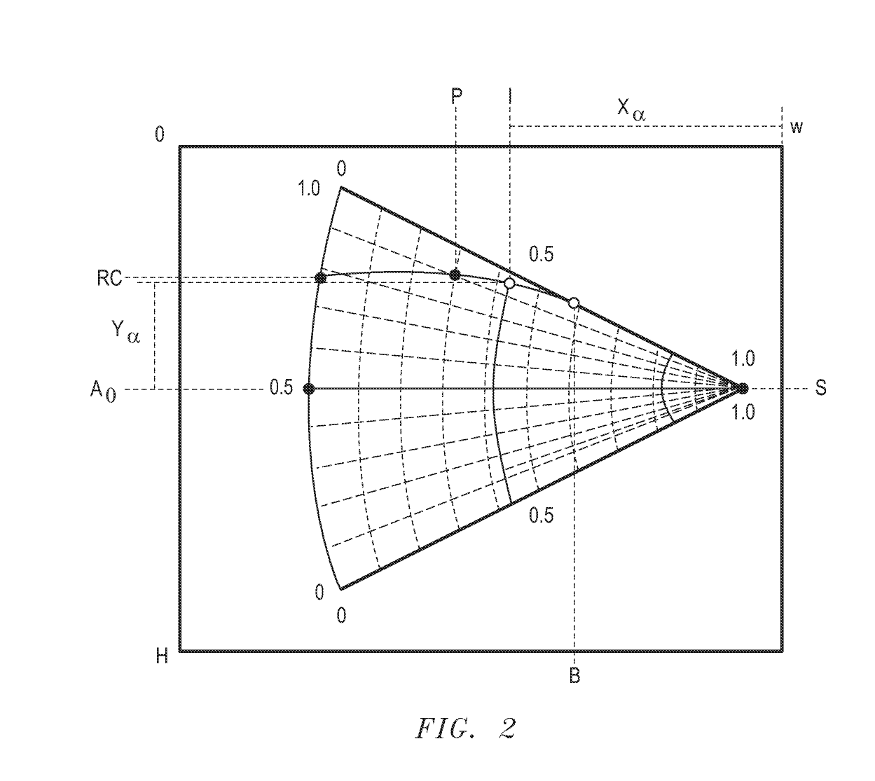

This description is in two parts, first describing the features of the inventive method, and then describing the rules of the inventive method. FIGS. 1-9 concern the features of the present invention. In FIG. 1, a two-axis radial coordinate system visualization graph 12 is depicted. An outer box 14 identifies the region in which the visualization graph is drawn. Each of the points 0, P, W, S, and H, are relative to this enclosed area. When drawing graphics to a screen, the upper-left corner is used as the origin, (0, 0), and the y-coordinates are positive below this point, and negative above it. This is why the upper-left corner of the outer box is labeled “0”, and the lower-left corner is labeled “H”, representing the height of the drawing region. The upper-right corner (W) is the width of the drawing region.

The Y axis of the visualization graph 12 is the ratio of (total correct calls) divided by the sum of (total correct calls) plus (total incorrect calls) (range from 0 to 1.0). The X axis of the visualization graph 12 is the percent of inconclusive calls (range from 0 to 100 percent). If a population of subjects is scored by a method of only random chance, the Y axis ratio value will be equal to 0.5 across the any range of inconclusives. This center line is defined as the point at which white alpha is equal to zero. A lie detection methodology above this line is above chance, and below this line is below chance. Chance is defined as random and without pattern, such as flipping a coin. If a normal coin was flipped ‘N’ number of times, and half of the flips were viewable, and half of the flips were hidden, then half of the flips that were viewable would be heads, and the other half of the flips that were viewable would be tails, as an example of random chance at 50%, with the hidden flips being an analogy to inconclusive calls. This random chance would be defined as having a general alpha value of zero at 50% inconclusive. If a method existed that could predict a coin flip above chance, it would have a general white alpha above zero.

The points A₀ and S identify the endpoints of the α=0 line. Relative to the visualization graph 12, the point A₀ is at 0% inconclusive, and.

$$\frac{0.5 correct}{correct + incorrect}$$

Relative to the visualization graph 12, the point S is at 100% inconclusive, and

$$\frac{0.5 correct}{correct + incorrect} .$$

The S point is also known as the singularity. Because the visualization graph 12 is circular, the alpha points are represented using polar coordinates. The point P identifies the coordinates for a sample visualization point. In the equations in this section, the variables A₀, Cₜₒₚ, C_{bottom}, H, P, S, W, X, X_{α}, Y, and Y_{α} refer to the corresponding points in the visualization graph 12. The x and y components of A₀, P, and S are relative to the outer box 14, with width W and height H. Coordinates with a a subscript are relative to the visualization graph 12 coordinate system. Coordinates without a a subscript are relative to pixel locations, with respect to a computer screen's Cartesian coordinate system. The points A₀, Ctₒₚ, C_{bottom}, and S are predefined based on the screen resolution and size of the client drawing area.

The length of the radius of the circle with respect to screen coordinates, R₀, can be found using Equation 1.1. This value is also used for scaling pixel locations to a specific % inconclusive value.

R₀=S·x−A₀·x Equation 1.1

The arc formed by the sector has a constant length of 1, with respect to the visualization graph coordinate system (L_{0α}). The length of this arc with respect to screen coordinates is L₀. This arc represents the ratio of

$$\frac{ correct}{correct + incorrect}$$

calls, ranging from 0 to 1. The angle (θ₀) subtended by this Y-axis arc is determined by Equation 1.2. R₀ refers to the radius of the circle, with respect to screen coordinates. The point Cₜₒₚ is the upper endpoint of the arc. The angle θ₀ is in radians.

$${θ}_{0} = 2 Arctan ( \frac{S . y - {C}_{top} . y}{S . x - {C}_{top} . x} ) \qquad Equation 1.2$$

The visualization graph maintains a constant value of θ₀ of 60°. All values with a a subscript are with respect to this arc. Equation 1.3 provides a visualization angular scaling factor between screen coordinates and polar coordinates, taking the visible angle into consideration. Any angle θ_{α} with respect to the visualization graph can be converted to a screen angle θ using this equation.

$${Scale}_{θ} = \frac{{θ}_{0 , α}}{{θ}_{0}} \qquad Equation 1.3$$

Equations 1.4 and 1.5 determine the distance from the alpha point to the singularity, in pixel and polar coordinates, respectively.

$$\begin{matrix}R = \sqrt{{( S . y - Y )}^{2} + {( S . x - X )}^{2}} & Equation 1.4 \\ {R}_{α} = \frac{R}{{R}_{0}} & Equation 1.5\end{matrix}$$

Equation 1.6 determines the % inconclusive based on the radius calculated in Equation 1.5.

I=1−R_{α} Equation 1.6

Equation 1.7 calculates the angle (in radians) of the alpha point relative to the α=0 line. If the point is above the line, then the angle is positive. If the point is below the line, then the angle is negative.

$$θ = Arctan ( \frac{S . y - Y}{S . x - X} ) \qquad Equation 1.7$$

Equation 1.8 determines the ratio of

$$\frac{ correct}{correct + incorrect}$$

calls based on the angle calculated in Equation 1.7. This ratio is denoted L since it is a value along the length of the arc.

$$L = \frac{θ}{{θ}_{0}} + \frac{1}{2} \qquad Equation 1.8$$

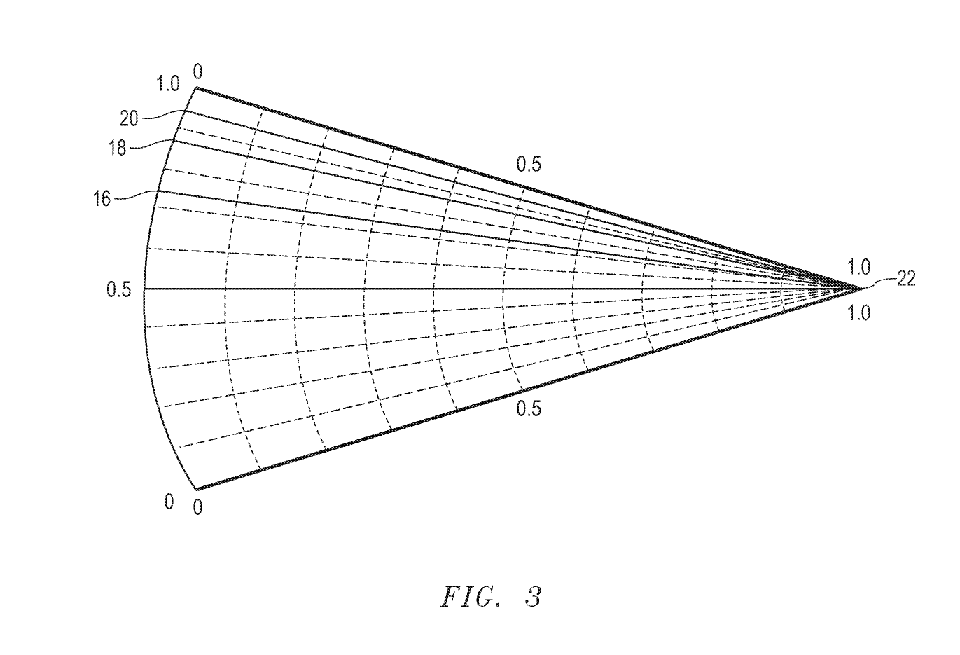

To determine an alpha value from the specific point, a least-squares-fit curve is calculated using the singularity, the specific point, and a random chance point (point RC in FIG. 2). The random chance point is defined as the specific point at 0% inconclusive that would result if half of the remaining inconclusive points were called correctly. Assuming a sample of 100 sessions, the number of correct and incorrect calls for a given (I, L) pair are found by Equations 1.9 and 1.10, respectively. Equations 1.11 and 1.12 determine the number of correct and incorrect calls from the remaining sessions, respectively. The overall ratio for random chance is calculated using Equation 1.13.

$$\begin{matrix}C = 100 L ( 1 - I ) & Equation 1.9 \\ Inc = 100 ( 1 - I ) - C & Equation 1.10 \\ {C}_{I} = \frac{100 I}{2} & Equation 1.11 \\ {Inc}_{I} = 100 ( I - \frac{1}{2} ) & Equation 1.12 \\ {L}_{RC} = \frac{C + {C}_{I}}{( C + {C}_{I} ) + ( Inc + {Inc}_{I} )} & Equation 1.13\end{matrix}$$

Given the values of R_{α} and θ, Equation 1.14 calculates the X-coordinate of alpha point (polar coordinates) for a specific point, and Equation 1.15 calculates the Y-coordinate of alpha point (polar coordinates).

X_{α}=R_{α} cos θ_{α} Equation 1.14

Y_{α}=R_{α} sin θ_{α} Equation 1.15

The least-squares-fit is a simple quadratic equation of the form y=ax²+bx+c. Equations 1.16-1.18 are used to calculate the constants a, b, and c. The subscript RC refers to the random chance point. The subscript S refers to the singularity. The point values with no subscript refer to the specific point. All coordinates are in polar coordinates.

$$\begin{matrix}a = \frac{\frac{{Y}_{α} - {Y}_{R C , α}}{{X}_{α} - {X}_{R C , α}} - \frac{{Y}_{S , α} - {Y}_{α}}{{X}_{S , α} - {X}_{α}}}{{X}_{R C , α} - {X}_{S , α}} \\ for “ a ” \\ & Equation 1.16 \\ b = \frac{{Y}_{RC , α} - {Y}_{α}}{{X}_{RC , α} - {X}_{α}} - a ( {X}_{RC , α} + {X}_{α} ) \\ for “ b ” \\ & Equation 1.17 \\ c = {Y}_{RC , α} - a {X}_{RC , α}^{2} - {bX}_{RC , α} \\ for “ c ” & Equation 1.18\end{matrix}$$

The value of Y_{α} is relative to the α=0 line, not to the ratio of 0 along the curved Y axis. While the curve must be drawn with an offset of

$$sin ( \frac{{θ}_{0 α}}{2} )$$

(the y-coordinate of the α=0 line in polar coordinates), deriving the equation in this form slightly simplifies computing the area used for the alpha value.

Referring now to FIG. 2, the alpha value calculation is a two-step calculation. In step 1 (Equation 1.19) of the method of the present invention, the percentage of area above the α=0 line that is enclosed between the α=0 line and the alpha curve is determined. The first two terms in the numerator are the total area between the alpha curve and the α=0 line, between the singularity and the intersections of the alpha curve and the curved ratio axis. The lower bound of the integral is the point at which the alpha curve crosses the upper or lower boundary of the graph (point B in FIG. 2). Any area outside the upper and lower boundaries of the graph is undefined. If the alpha curve does not cross over this boundary, then point B=S, and X_{B,α}=0. Point B is determined by substituting the equation for the upper and lower boundary lines into the equation for the alpha curve, and finding a positive root between 0 and 1. The upper bound of the integral is the point at which the alpha curve intersects the specific inconclusive arc (if applicable) (point I in FIG. 2). This point is found by applying a binary search to the alpha curve, with the X value ranging between 0 and 1.0. Point I is located when the resulting point is within a specified tolerance of the radius of the specific inconclusive arc. The second term is the triangular area between the singularity, the α=0 line, and point B. When B=S, this area is 0. The third term in the numerator is the total area between the α=0 line and a straight line connecting the singularity to the random chance point. The fourth term in the numerator is the area of the right triangle formed by the α=0 line and the line connecting the singularity to the random chance point. The

$$\frac{{θ}_{0}}{4}$$

in the denominator is the total area above the α=0 line.

$$A \% = \frac{\begin{matrix}( {{\int }_{{X}_{α = {X}_{Β , α}}}}^{{X}_{I , a}} {aX}_{α}^{2} + {bX}_{α} + c ) + ( \frac{{X}_{B , α} {Y}_{B , α}}{2} ) + \\ ( \frac{{R}_{α}^{2} \cdot Arctan ( \frac{{Y}_{I , α}}{{X}_{I , α}} )}{2} ) - \frac{{X}_{I , α} {Y}_{I , α}}{2}\end{matrix}}{\frac{{θ}_{0}}{4}}$$

Equation 1.19—Percentage of area above α=0 enclosed by the alpha curve

In step 2 (Equation 1.20) of the method of the present invention, this percentage is mapped to a base 2 logarithmic curve.

α=−log₂(1−A%) Equation 1.20—Alpha value from area percentage

Equation 1.19 is used for calculating the specific alpha value, where a specific inconclusive rate is defined. The general alpha value is a special case of specific alpha, where the inconclusive rate is 0. In this case, I=RC, as defined in FIG. 2.

For drawing alpha points to the screen, given the (I, L) pair, first the values of R and 8 are calculated by reversing Equations 1.4, 1.5, and 1.7. Given R and 8, the pixel coordinates can be found using Equations 1.21 and 1.22.

X=S·x−R cos θ Equation 1.21—X-coordinate of alpha point (pixel location)

Y=S·y−R sin θ Equation 1.22—Y-coordinate of alpha point (pixel location)

Referring now to FIG. 3, the middle line is the white alpha 1 boundary, the line ¾ up is the white alpha 2 boundary, and the upper line is the white alpha 3 boundary. FIG. 3 illustrates the log-base-2 scale of the white alpha score value. To define the alpha scale, one can imagine that the area above alpha zero is cut in half, as one would cut a pie slice in half. This bisecting line equally divides the available area comprising possible calls above chance, across all inconclusive possibilities. The line dividing this above chance area by half will be defined as equal to an alpha of a value of 1. If this upper area above alpha 1 is divided in half again, its bisecting line will be defined as an alpha of 2, and so on, with each halving of the area remaining raising the value of alpha by 1.

Next, to define the alpha boundary, one must realize that in the real world of polygraph methodology development, the alpha divisional lines are not linear and straight. But, as described earlier, those lines are represented by the ratio of (correct calls)/(correct calls+false calls) that will decline as inconclusives decline, in a non-linear way for different scoring methodologies at four definable reference points common to all lie detection methodologies. For simplicity, one can imagine cutting an irregular pie slice with four connecting dot progressive points moving left from the above pie center.

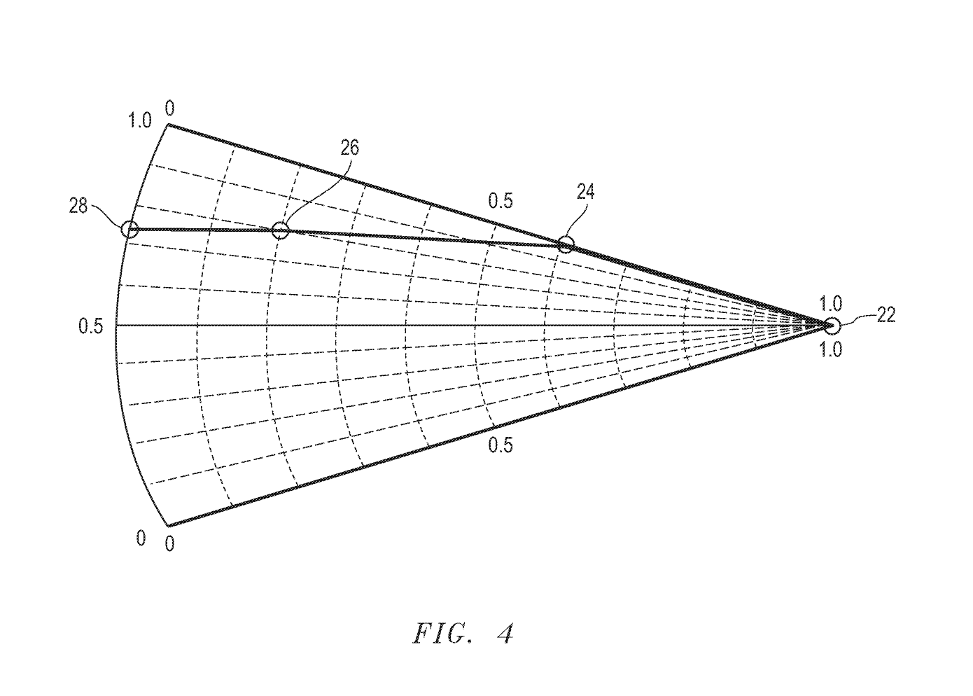

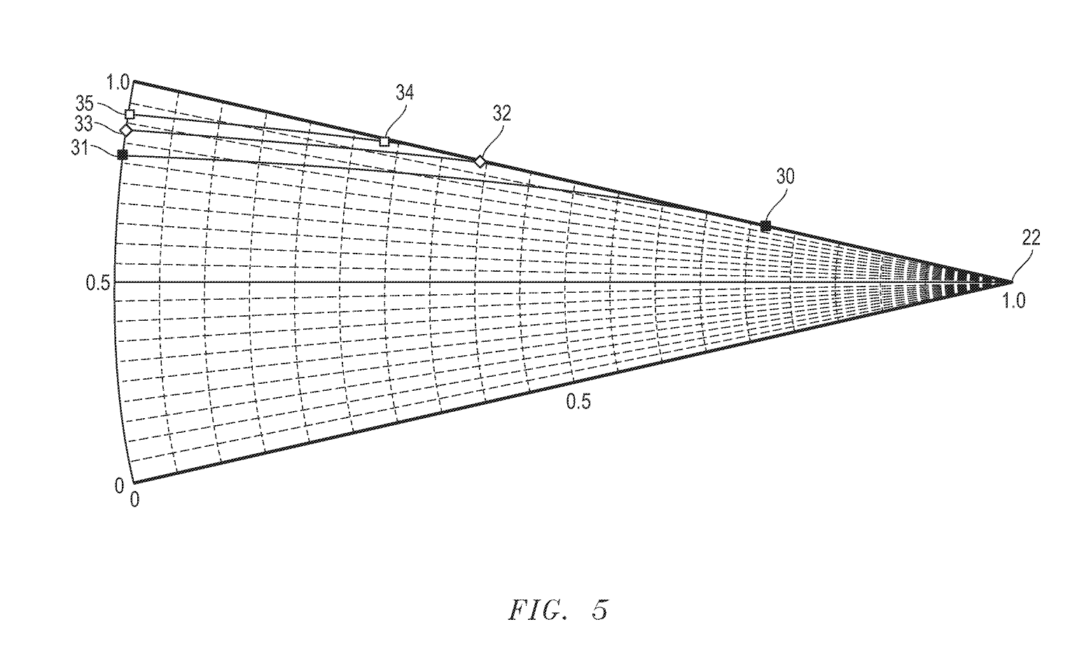

Next, and referring now to FIG. 4, one must define the four reference points that draw any lie detection methodologies alpha boundary. The first point 22 is called the starting singularity (i.e., 0/0) and is at 100% inconclusive. This is the starting point of the divisional alpha line.

The second data point 24 is called the perfection point, and is the smallest inconclusive % value that retains a Y axis value of 1 (i.e. no false hits). This can be found by either: (a) if the polygraph algorithm, or methodology, as a first stage of its approach, counts and removes “exclusively” DI (Deception Indicated) and NDI (No Deception Indicated) outer ranges, then the inconclusive % value at which this occurs is defined as the second point on the inconclusive axis where the Y axis equals 1 (also called the perfection point); or (b) if a method produces only a gross final result. Then the algorithm's final result may be rank-ordered, and the exclusively correct calls at the DI and NDI extremes are summed. All other values in the population are, for this purpose, redefined as inconclusive. This comprises the second data point 24 for the alpha plot boundary (where the Y axis equals 1). The region between points 22 and 24 is defined as region A (purely correct calls).

If a methodology (hand score, etc) has no exclusively pure DI or NDI regions for a population in its results, then data point number two (perfection point), and the singularity point of origin are the same.

The third data point 26 is the Y axis value that a given algorithm's final results would produce when applied to a given population, and its associated inconclusive value. The region between points 24 and 26 is defined as region B. The choice for where Region B ends is defined as where an algorithm designer determines the best compromise exists between gaining more correct lie detection calls but at the expense of gaining some mistaken calls for a given lie detection methodology rule set.

The fourth data point 28 is drawn from data point three, to the far left, where the inconclusive % is equal to zero. The slope of the line drawn is equal to random chance being applied to the remaining inconclusives present at data point three. Stating this another way, point four equals the number of false calls that have occurred up to point three added to half of the remaining inconclusives, then once summed, divided by the number of subjects in the data population, to produce the Y value at point number four having no inconclusives. The random chance point can also be defined as the Y value that would result if, of the remaining inconclusives at point three, half were called correctly and the other half incorrectly, leaving no inconclusives. The region between points 26 and 28 is defined as region C, which is the specific white alpha point for a methodology if it is forced to have no inconclusive.

These four data points, when drawn on the alpha plot shown in FIG. 4, will create a boundary that will divide the area that is above chance into two segments. The geometrical area ratio of these two segments is determined by dividing the upper area by the lower area. This ratio is applied to the above described descending half, by half, etc. scaling calculation, to determine the general alpha. General alpha is the alpha value when the left most boundary on the alpha polar plot is bounded by zero percent inconclusive value.

The above four-point method for calculating the general alpha for an entire population can also be calculated in an identical manner for the same population's DI and NDI values, to produce a general DI alpha, where DI stands for deception indicated, and the general DI alpha curve is produced from the least squares fit curve for the DI point for the end of region B as shown above. The DI value at the end of Region B is equal to (the number of correct DI calls) divided by (the number of correct DI calls plus the number of NDI values that are incorrectly called DI), but not including the inconclusive calls. A general NDI alpha is produced where NDI stands for deception indicated and the general NDI alpha curve is produced from the least squares fit curve for the NDI point for the end of region B as shown above. The NDI value at the end of Region B is equal to (the number of correct NDI calls) divided by (the number of correct NDI calls plus the number of DI values incorrectly called NDI), but not including the inconclusive calls.

The Y axis ratio for a general DI alpha is defined as: (Correct DI calls) divided by ((correct DI calls) plus (incorrect DI calls)) Incorrect DI calls include DI points that are called NDI.

The Y axis ratio for a general NDI alpha is defined as: (Correct NDI calls) divided by ((correct NDI calls)+(incorrect NDI calls)). Incorrect NDI calls include NDI points that are called DI.

A subset of general alpha is specific alpha. Specific alpha is defined as where a researcher chooses to use a methodologies alpha boundary curve shape, with a specific inconclusive percent other than zero for its left-most boundary in re-calculating an area ratio, or specific alpha ratio.

Specific alpha is useful for comparing the accuracy of two different methodologies at a specific inconclusive value, otherwise not common to them both. By definition, if an alpha value of one methodology is one alpha higher it is twice as accurate, with an alpha of two greater, then it is four times as accurate, etc.

Another use of specific alpha for researchers is in designing scoring methodologies that trade off correct calls, incorrect calls, inconclusives, DI or NDI focus, and population mix to fit not-yet-met missions for military, intelligence, or other polygraph needs in a deterministic and methodical manner.

Infinite specific DI alpha is the percent inconclusive point in a progressive methodology up to which exclusively DI calls can be expected. It is also defined as the region bounded by DI point number 24 on the general DI alpha graph (see FIG. 4, where the curve applies to correct and incorrect DI calls only) and alpha singularity point of origin, point 22. At point 22 where inconclusives are 100% a mathematical singularity exits, because there are no data points in existence, then the alpha value is (0/0), and can not be calculated. By definition this is called a singularity.

Infinite specific NDI alpha is the percent inconclusive point in a progressive methodology up to which exclusively NDI calls can be expected. It is also defined as the region bounded by NDI point number 24 on the general NDI alpha graph (see FIG. 4, where the curve applies to correct and incorrect NDI calls only) and alpha singularity point of origin, point 22.

A population of a class of polygraph subjects may be intrinsically weighted heavily toward truthful (such as testing for spies in an intelligence agency population), or deceptive (such as testing a population of repeat offenders on probation). When this occurs, false hits between alpha point 24 and point 28 for the DI/NDI dominant portion of the population can overwhelm the smaller population component with false hits, if the testing rules are not corrected for this imbalance. Intrinsically, rules that generate a white alpha score between point 22 and point 24 are largely immune to this imbalance.

Referring now to FIG. 5, there is depicted a current working white alpha accuracy graph. Since the word alpha by itself is often used in mathematical equations for many purposes, the method of the present invention defines white alpha as a descriptive term, of its own, to represent the method of measuring how much a methodology is above random chance by the method described in this document. White alpha is the ratio of the area above the alpha boundary to the area below the alpha boundary on a polar coordinate system for a log to the base of two. White alpha has two sub categories, “general white alpha” and “specific white alpha”. General white alpha is where the left most alpha graph surface area ratios are bounded by the 0% inconclusive boundary, and specific white alpha is where the left most alpha graph surface area ratios are bounded by a specific percentage inconclusive boundary such as 15% for example. In both cases the lower defined boundary of the surface area will be the bisecting line midway.

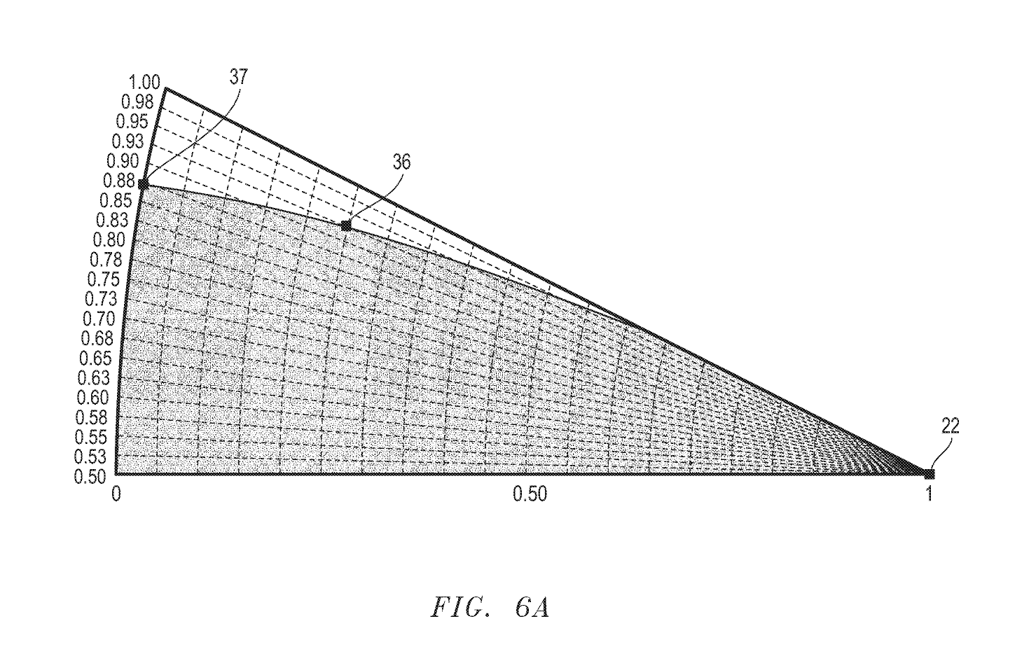

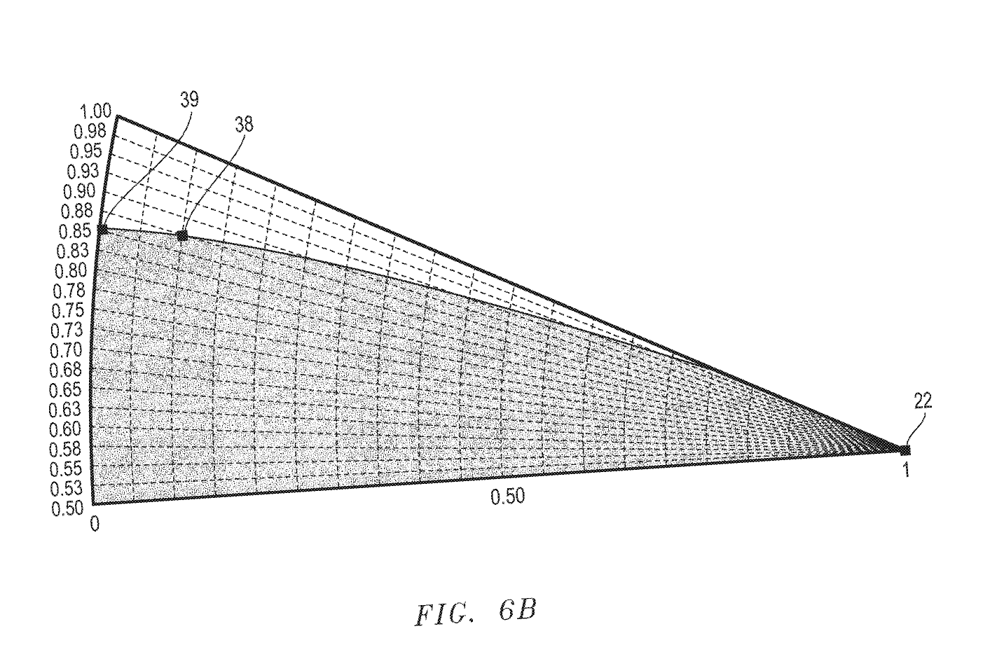

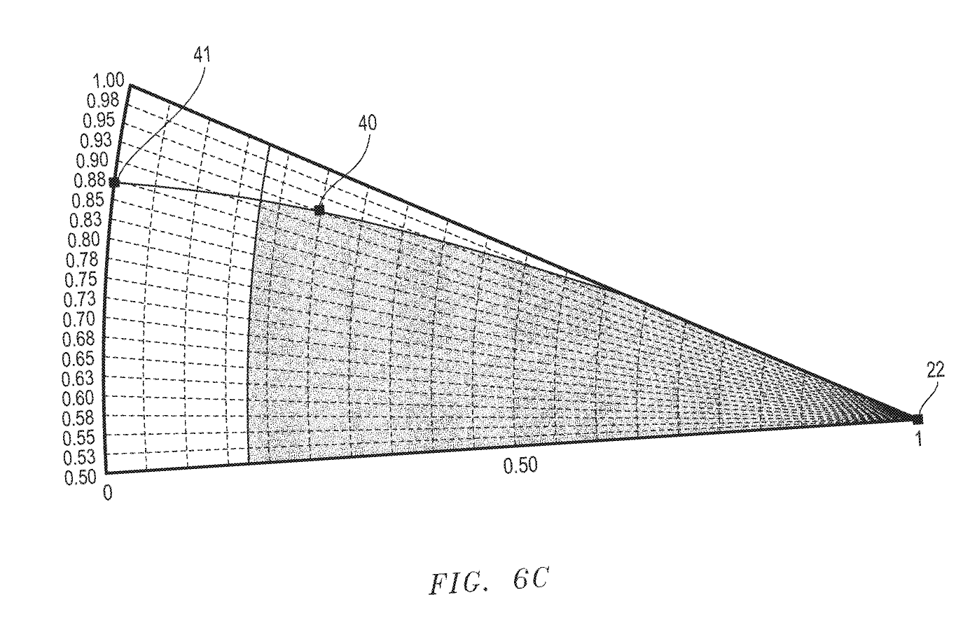

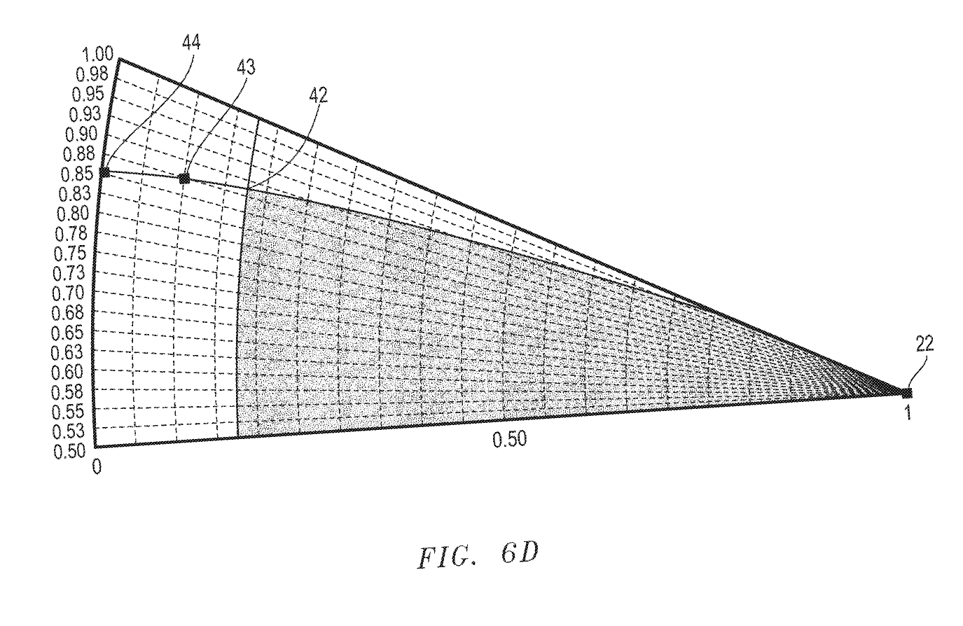

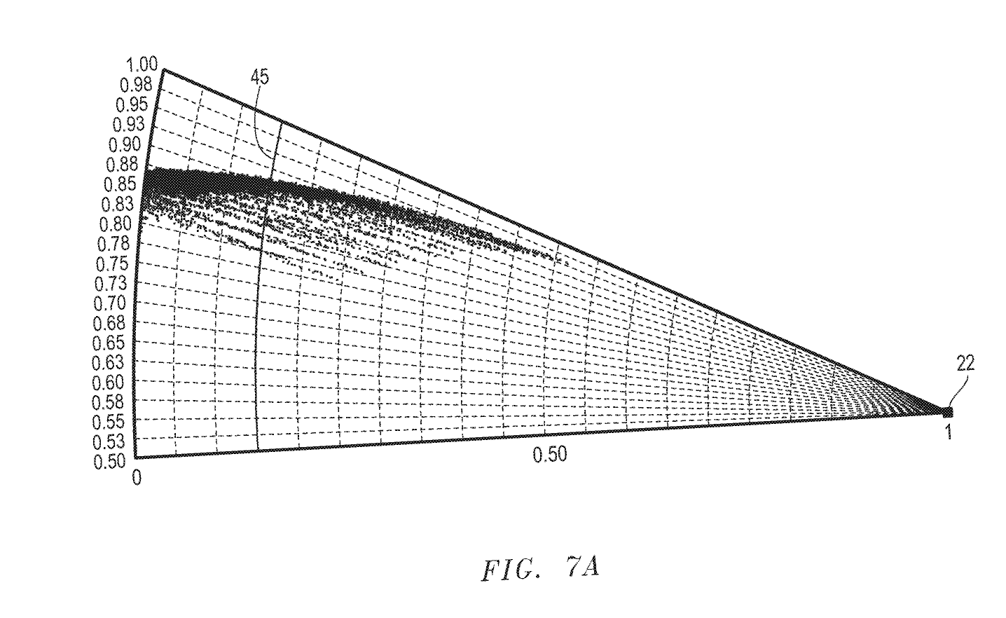

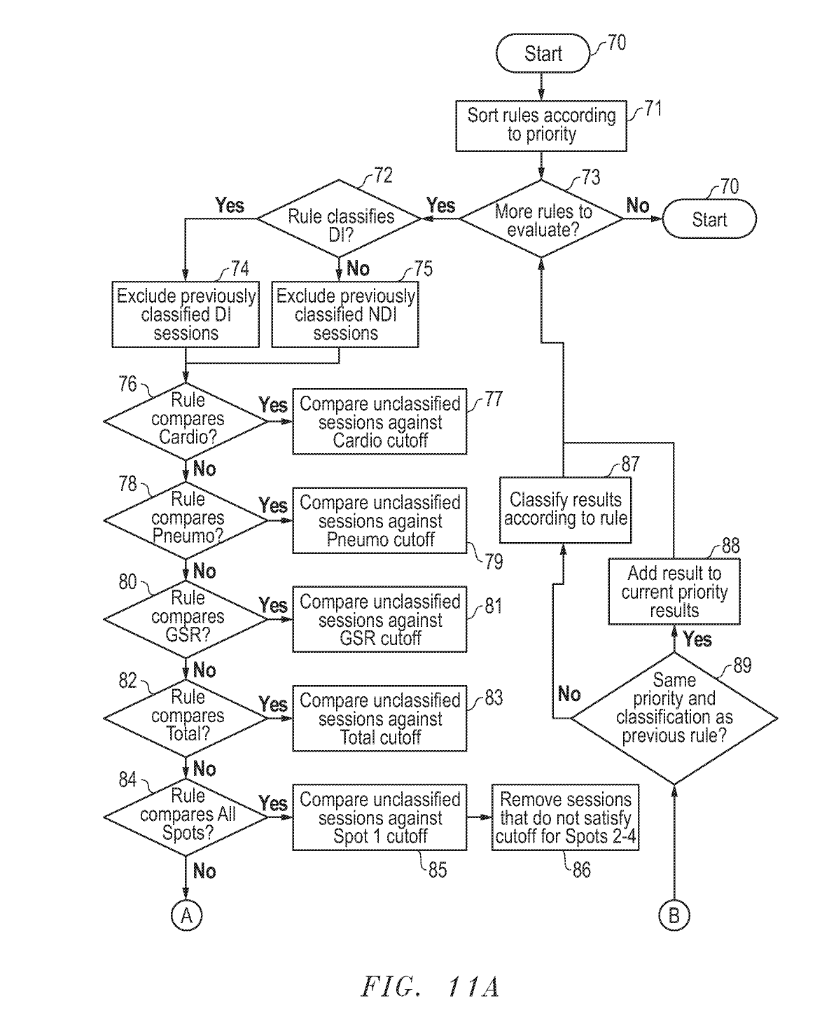

Referring now to FIG. 6A, in operation, the method of the present invention can be used to compare different lie detection methodologies. FIGS. 6A and 6B show the general white alpha curve for two different lie detection methodologies (with the white alpha curve projected out to zero percent inconclusive calls), and their corresponding white alpha values. FIGS. 6C and 6D show the specific white alpha curve for the same lie detection methodologies, with the white alpha curve projected to the inconclusive percentage halfway between the inconclusive percentage of each methodology. The inconclusive percentage for a given methodology is defined by the middle point on the white alpha curve (25% for FIGS. 6A and 6C, and 10% for FIGS. 6B and 6D). The specific inconclusive percentage is shown by the blue arc at 17.5% in FIGS. 6C. and 6D. The resulting specific white alpha score is an objective comparison of the two methodologies' accuracy when allowing the specified percentage of inconclusive calls.

Because any validated lie detection methodology with a research study will by definition state how many people were correctly classified, how many were incorrectly classified, and how many were inconclusive or unclassified, then with these three values a general or specific alpha value can be determined using the method of the present invention. An individual wishing to compare two lie detection methodologies to see which method is better overall can either compare their separate white alpha values or locate an inconclusive value half way between them and project their alpha boundary line to this midway inconclusive percent line and calculate the specific white alpha value at that inconclusive boundary. Thereby selecting the better lie detection method by this approach as shown here in FIGS. 6a, 6b, and 6c. In this example there are two competing lie detection methodologies that are applied to the same or similar population of 1000 police suspects. Many of the lie detection results for both methods are the same on these 1000 people, but some are different. The police department wishes to know which lie detection method is the most accurate at a selected tolerance of inconclusive lie detection calls.

In method one there are 700 correct determinations of truth and innocence (ie. calls), 50 incorrect calls, and 250 inconclusive calls. (i.e., 700/750 gross accuracy=0.93) versus 250/1000 inconclusive=25% inconclusive. In method two there are 800 correct calls, 100 incorrect calls, and 100 inconclusive calls. (i.e., 800/900 gross accuracy=0.888) versus 100/1000=10% inconclusive. So in method one general white alpha is 3.0 on the log 2 scale described above.

Referring now to FIG. 6B, method two general white alpha is 2.55.

Referring now to FIG. 6C, the user of the present invention now places the left area boundary midway between the inconclusive value of method one and method two (ie. 17.5%) and measuring their common specific white alpha values. This approach gives lie detection method one a common specific white alpha value of 3.63.

Referring now to FIG. 6D, lie detection method two gives a common specific white alpha value of 2.93. So, since the lie detection method one produces a specific white alpha of 3.63, and thus is greater than the lie detection method two value of 2.93, in its extracting above-chance patterns, then the best lie detection method for this population of people is method number one.

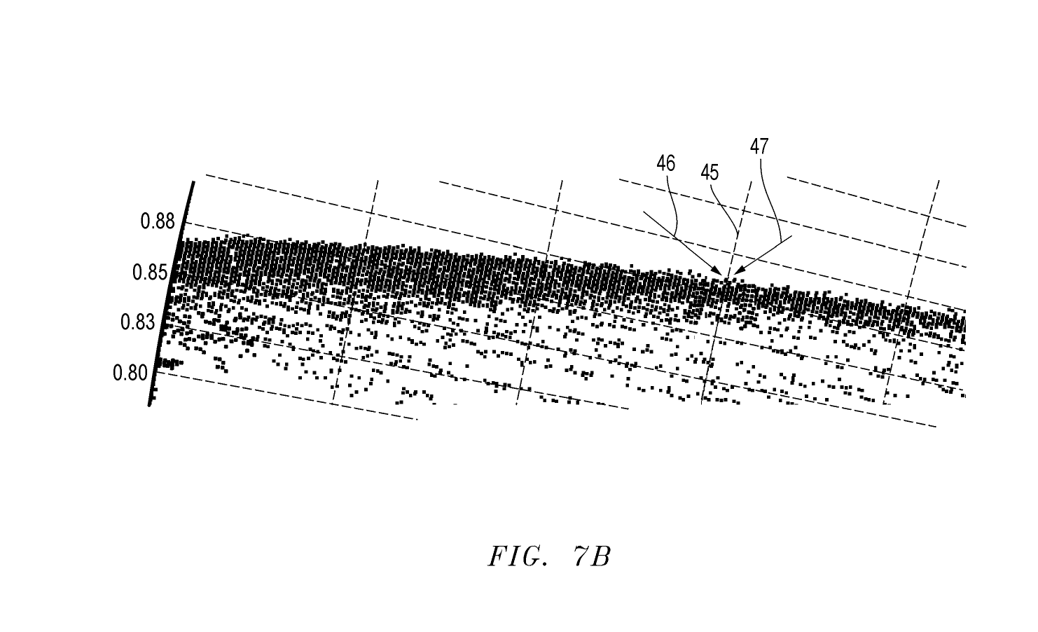

Referring now to FIG. 7A, in another application of the method of the present invention, a lie detecting equipment company has, or is developing a lie detection analysis method, or algorithm, and wishes to adjust this method's internal decision rules in different ways and see which of these rule changes produce the best results from all possible variations. Success in finding the highest specific white alpha value at a selected tolerance of inconclusive value will give that company greater accuracy in its detection of lies.

In this white alpha use, each component of a lie detection rule set is given a priority and range of cutoff values. For instance, the first component may be the cardio channel, which must be between 1 and −4 to call a session DI, and between 0 and 5 to call a session NDI. This component may be assigned a priority of 1. Once all rule components have been assigned, all possible non-overlapping combinations of cutoff values within the defined ranges are tested. Referencing the example above, the first cardio rule tested may be DI is less than −4, and NDI is greater than 5. The next test may be DI less than −3, and NDI greater than 5. All combinations of the above values will be tested, except for the overlapping ones of DI less than 0 or 1, and NDI greater than 0 or 1. The points shown on the white alpha graph in FIG. 7A are the general white alpha points generated by each possible rule set. A given set of rules are applied to a population of known lying or truthful subjects, and its general white alpha value is found and plotted as a point on the white alpha radial grid. Then the lie detection method that was used has one of its internal parameters incremented by one, and the general white alpha is calculated again and plotted again, etc., until all desired variations of a rule set are considered and plotted. The lie detection rule set with the best white alpha score at a particular inconclusive percent (such as 15% inconclusive) will be highest on the vertical reference line at that inconclusive percent.

Referring now to FIG. 7B, the lie detection rule set that generated the highest white alpha point along the 15% inconclusive vertical arc (pointed to by the arrows) will be the most accurate rule set that allows 15% inconclusive for the mix of deceptive and truthful subjects this test was run on. The commercial lie detection application that makes use of this insight will be superior in performance at that inconclusive parameter, than other commercial applications not using this sequence of processes for the same lie detection methodology.

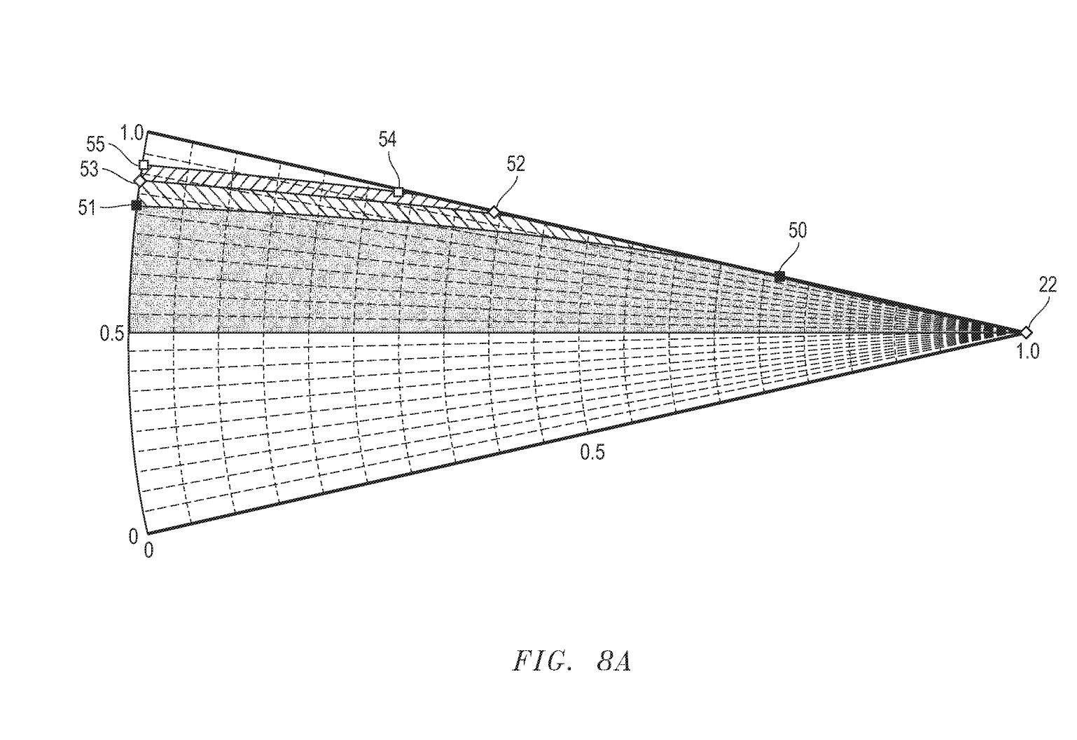

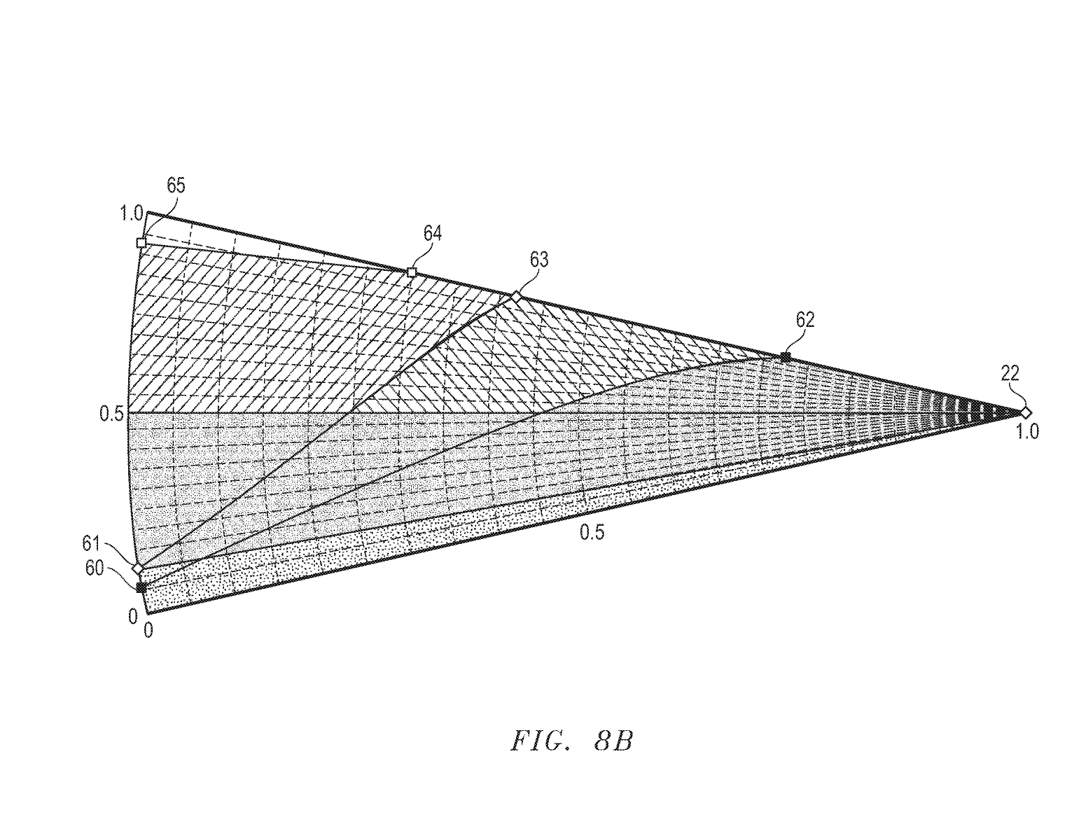

Referring now to FIG. 8A, the historic problem that lie detection methodology has with extreme population basis is, for example, where in this case an intelligence agency wishes to purchase a lie detection methodology able to detect a very tiny number of foreign spies in a profoundly large population of intelligence agency employees. Using the region A concept described earlier (defining the region of purely correct calls on extreme deceptive and truthful regions), one can use the following example to optimize an intelligence agency's needs for optimal lie detection rule set design. Starting with a known population with confirmed lies and truths one can plot this white alpha plot with these defined region A subjects.

The curve that is drawn from point 22 to point 52 to point 53 is the general white alpha curve, such that all subjects in the exclusively DI (point 22 to point 54) and NDI region A from point 22 to point 50. So, for FIG. 8A the exclusively and fully deceptive region A, drawn from point 22 to point 54, is the general DI white alpha curve, such that all subjects in only the exclusively DI region are called correctly (region A DI). The white alpha curve drawn from point 22 to point 50 in the darkly shaded region to the right of point 50 is exclusively truthful. In FIG. 8A, 70.2% of all DI subjects were correctly called DI, and the remaining 29.8% were inconclusively called, while 21.4% of all NDI subjects were correctly called NDI, and the remaining 78.6% were inconclusively called.

Because region A is largely immune to population basis as described earlier an intelligence agency may either modify their region B rule selection to fit a different number of tolerated mistakes on the truthful population, or set a departmental policy that region A deceptive evaluations in a given lie detection methodology would trigger a predetermined departmental policy suitable for high likelihood of spies. This is only one example of using white alpha region A to fit custom needs of extreme basis populations.

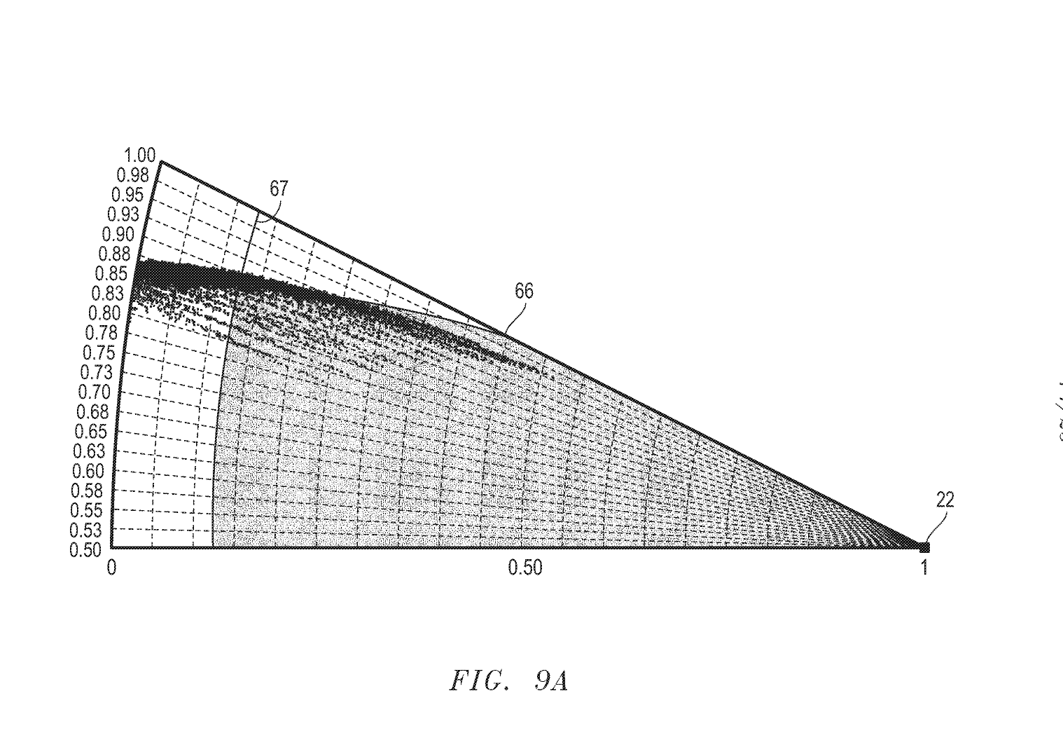

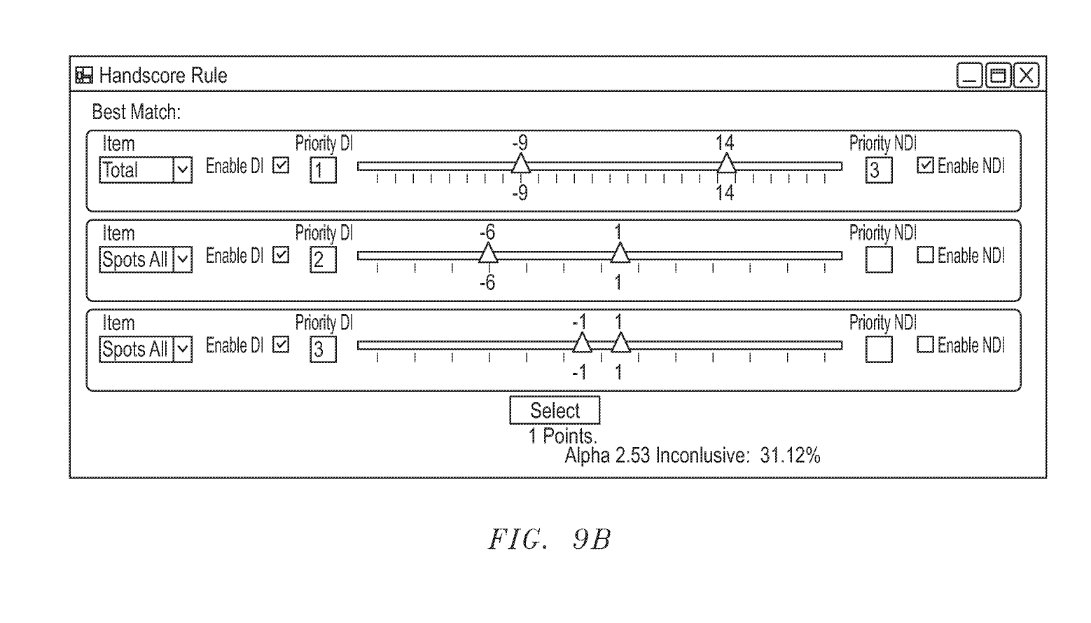

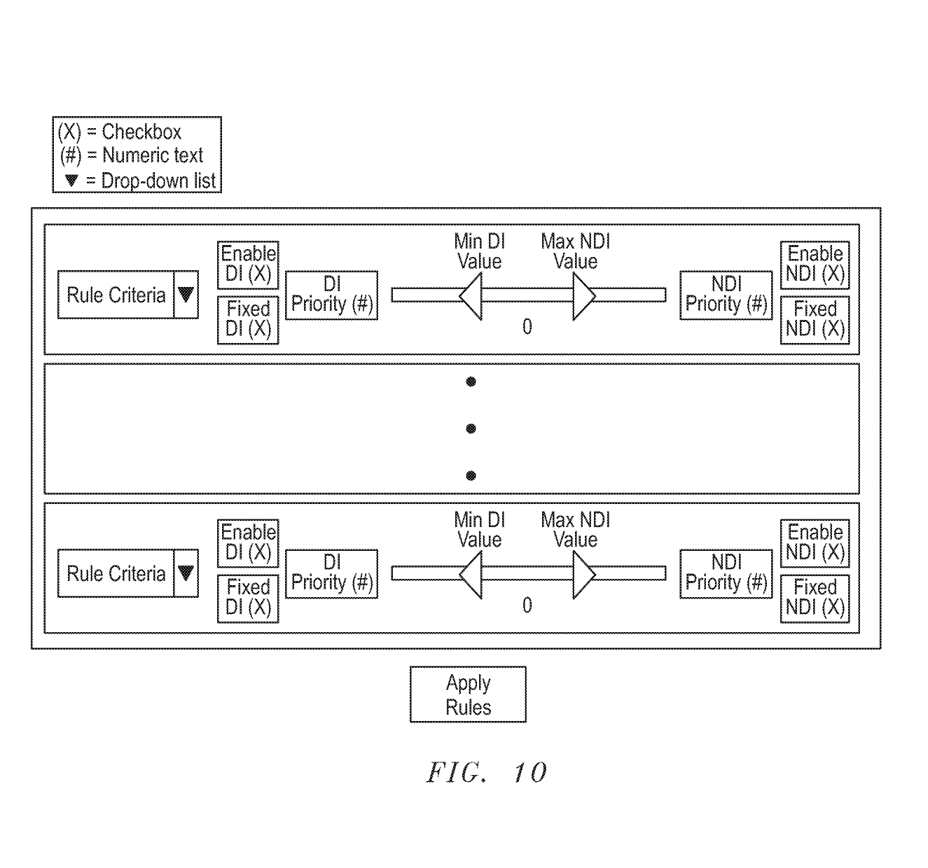

Referring now to FIG. 9A, cancer diagnosis methodology has parallels to lie detection methodology in that both deal with two states of outcome (truth/lie) for one and (cancer present/not present) for the other, and both have a range of inconclusive outcomes when different rule sets are used on their separate measuring criteria. In polygraph lie detection there are three primary sensors breathing, sweating, and heartbeat. In cancer blood tests there may be one blood test, or many blood tests, that look for cancer in different ways. Typically in an early disease state, such blood tests produce two bell shaped curves that overlap each other to varying degrees. This overlapping range is analogous to a polygraph inconclusive determination. If several medical tests are combined and averaged some improvement in accuracy can occur, but white alpha offers a potentially better method than averaging to improve early cancer diagnosis when multiple medical test are present for a particular patient when a study has been done with similar patients containing the same tests on a past known population of patients.

First, just as in the above lie detection methodology general white alpha calculation, a range is set for the rules to be used to determine a cancer/no cancer call identical to the process for a lie detection lie/no lie call.

Once these rule ranges are set all possible rule combinations are calculated, and their white alpha points are graphed. Then the medical researcher can select the highest white alpha point on line 67 of FIG. 9A, and the rule set that produced it. The most vertical white alpha point on line 67 will have been produced by a method score rule that generated that white alpha point. FIG. 9B shows a rule set that would have produced a particular point at the top of line 67 in FIG. 9A. The number of rule sets that generated a higher white alpha score is displayed in FIG. 9A. Any point above and to the left of a given reference on the white alpha graph will have a higher white alpha score than the reference, since by definition the white alpha score is determined by the area under the white alpha curve. Any point in the upper left region corresponds to a curve with greater area than the reference point's curve. This set of cancer blood test rules offers an optimized way to determine what blood test rules when applied to such past populations of patents that can be applied to future patents with greater earlier detection accuracy than just averaging results in some way as is sometimes done.

The rest of this detailed description presents the rules of the inventive method, as illustrated in FIGS. 10-15. Referring now to FIG. 10, the rule analysis dialog box shown in FIG. 10 allows the user to specify a set of rules for determining if a session is truthful, deceptive, or inconclusive. The available criteria are: Total Score, GSR, Cardio, Pneumo (Total), All Spots (up to 4, all must satisfy the rule), and Any Spot (up to 4, at least one must satisfy the rule).

In FIG. 10, the Rule Criteria drop-down list allows the user to select from the criteria mentioned above. The Enable DI and Enable NDI checkboxes enable the rules to be turned on and off individually, without having to clear them. The Fixed DI and Fixed NDI checkboxes allow the cutoff values to remain fixed for the specified rule when running through general Autoscore. The DI Priority and NDI Priority numeric text boxes specify the priority for the given rule. The sliders allow the user to specify the cutoff values for classifying a session as DI or NDI.

Up to twelve unique priorities may be entered in the Rule Analysis dialog. When setting rule priorities, more than one rule criteria may share a priority. For example, the third priority in the standard DACA Handscore rules states that if the total score is greater than or equal to “plus six”, and All Spots are greater than or equal to zero, then the session is classified as NDI. For a session to pass this priority, it must satisfy both of these rules.

Also, a rule can have more than one priority. For instance, priority one may state that if the GSR value is less than or equal to “minus four”, then the session is classified as DI. Priority five may state that if the GSR value is less than or equal to “minus one”, and the Cardio value is less than or equal to “minus five”, then the session is classified as DI.

Clicking the Apply Rules button will apply the current set of rules to the sessions displayed on the 2D scatter plot. Sessions that are classified as DI will be highlighted in the Group One color. Sessions that are classified as NDI will be highlighted in the Group Two color. Sessions that are not classified DI or NDI will remain un-highlighted.

When the alpha graph is present, the results of applying a rule set generate an alpha curve. Sessions that are in the DI directory and are classified as DI according to the current rule set are considered correct DI calls. Sessions that are in the NDI directory and are classified as NDI according to the current rule set are considered correct NDI calls. Sessions that are in the DI directory, but are classified as NDI according to the current rule set are considered incorrect NDI calls. Sessions that are in the NDI directory, but are classified as DI according to the current rule set are considered incorrect DI calls.

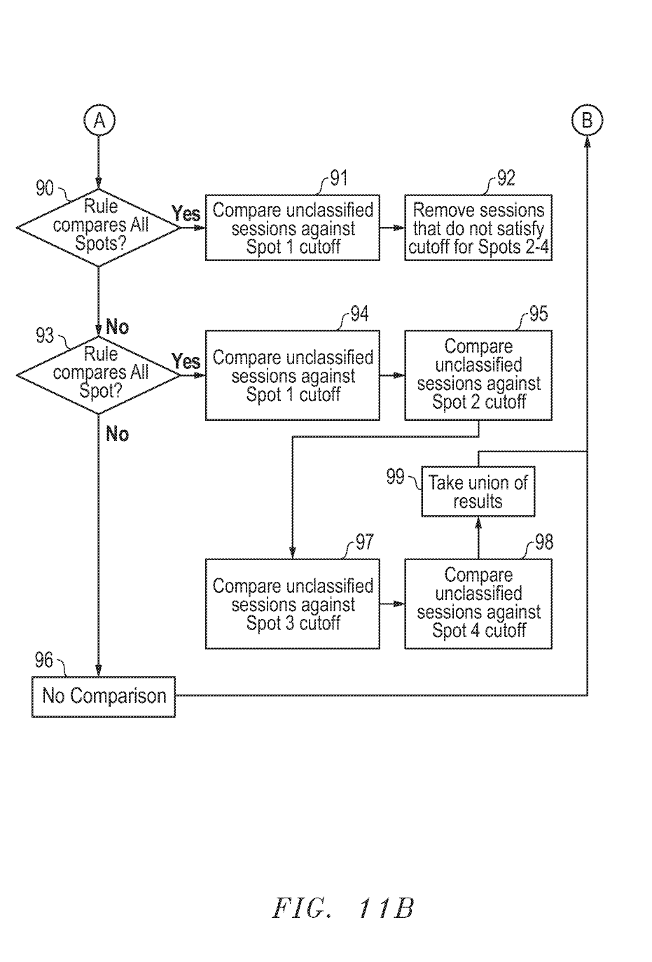

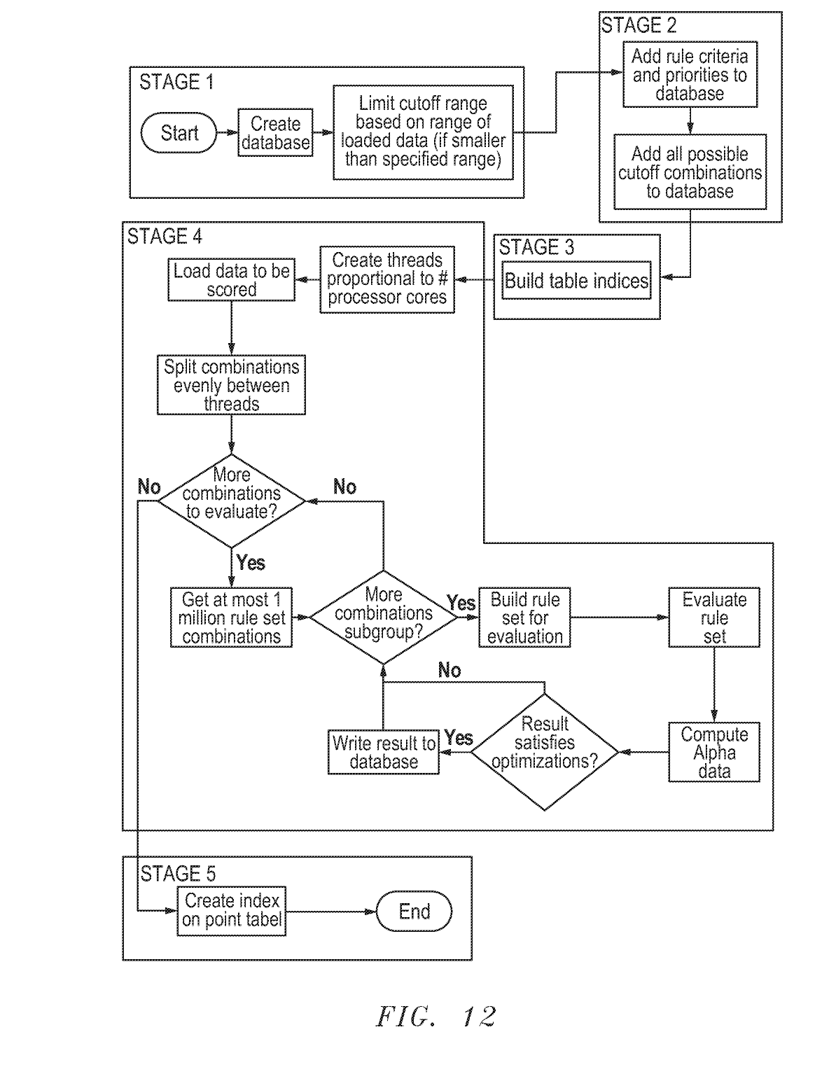

Referring now to FIGS. 11A and 11B, a single rule set is evaluated in priority order. In step 50, the rules are sorted according to priority. In steps 72-75, once a session is classified as DI or NDI, it is excluded from further evaluation, since the rules at lower priorities will not affect its classification. When more than one rule share a priority, first the DI rules are evaluated, then the NDI rules are evaluated for that priority. If a DI and NDI rule share a priority, they do not affect each other. In steps 76-86, examination sessions are not classified until all rules of a given priority have been evaluated.

Autoscore algorithms are used for optimizing rule sets. There are two autoscore methods available: general autoscore and progressive autoscore. The general autoscore method evaluates all possible combinations of rule sets, given a base set of rules. The priorities can vary or remain fixed, and the cutoff values are varied between zero and the specified values. If the specified value has is outside the range of values represented in the actual data set, then the range of possible combinations is limited by the real data set. For instance, if one of the rules states that a GSR value less than or equal to minus ten is classified as DI, but the minimum GSR value in the data set is minus five, then only values between minus five and zero will be used for the GSR channel during general autoscore. However, if the fixed checkbox is selected for a particular rule (see FIG. 10), then only the specified value will be used for that rule; i.e. the range of values between zero and the selected value will not be tested. The result that is saved for each evaluated rule set is the set of DI, and NDI, and combined DI+NDI alpha points for each evaluation.

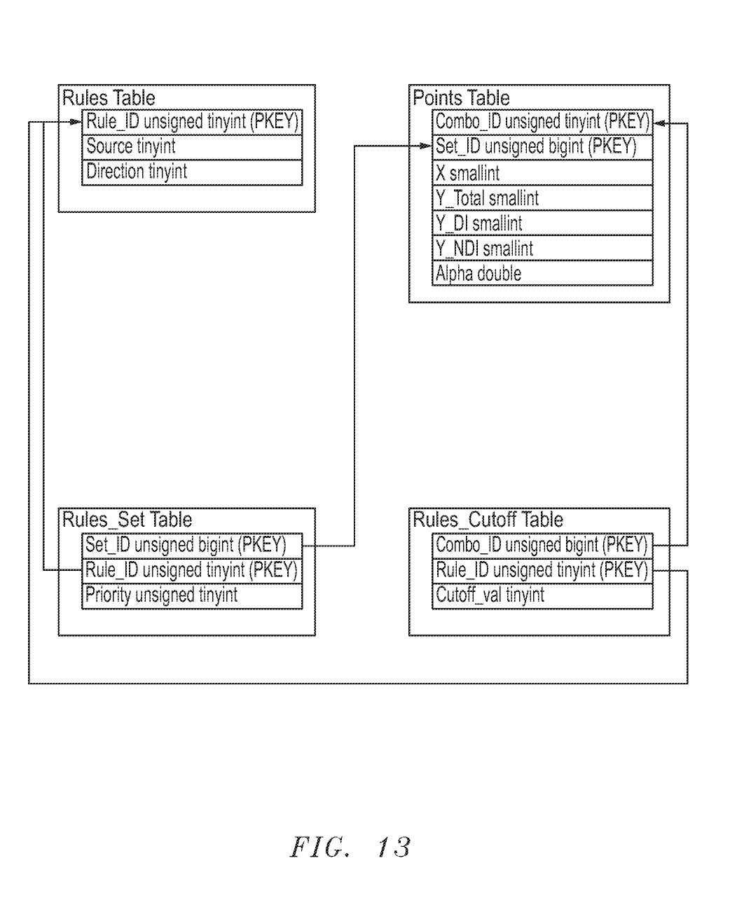

Referring now to FIG. 12, general autoscore is an automated procedure for generating the general white alpha score all possible combinations of lie detection rule sets given a range of cutoff values. The general autoscore runs through five stages. In Stage 1, the program initializes the database. If the specified database does not exist, then it is created. Otherwise, any data currently in this database is deleted. Also, any indices on these tables are deleted as well, to speed up this stage and the following stage.

In Stage 2 of FIG. 12, the program computes all possible inputs. This involves assigning a unique identifier to each rule criteria, determining the possible priority groupings (if applicable), and all possible combinations of cutoff values for each rule.

In Stage 3 of FIG. 12, the program indexes all possible inputs. For large sets of input, building an index on the possibilities allows any future queries on this data to run more efficiently. The index is built after all the possibilities have been added to the database because otherwise, the index would be constantly updated as the values are entered into the database, thus slowing the process down tremendously.

In Stage 4 of FIG. 12, the program evaluates all rule possibilities. This stage can be multi-threaded if the user's computer has multiple processor cores. Each thread evaluates an equal share of rule sets and stores the results in the database. Each thread operates on its portion of rule sets in groups of 1 million. This is the limit at which the query will continue to use the indices built on the initial data tables. The threads must be synchronized when computing the alpha results for each rule set, and when running significantly long queries on the database in order to prevent timeout errors. The results are compared to any optimizations specified by the user before being written to the database. If any rule evaluations do not meet the optimization criteria, they are not written to the database. This can save a significant amount of both space and time, since the bottleneck is writing the results to the database.

In Stage 5 of FIG. 12, the program indexes the results. While this stage may take several minutes, it greatly speeds up future queries when analyzing the results of the general autoscore run on the alpha graph. This includes determining which rule sets generated particular points on the alpha graph.

The results of the general autoscore are saved in a MySQL database for a few reasons. First, for a wide range of cutoff values and with five or more rules, the required amount of storage quickly grows beyond available RAM. For instance, if only six rules are used, and they are all set to their maximum ranges, around 1.6 GB of data is required to store the results of the evaluation, and the rule sets matching each result. Second, the results of the autoscore should be available long after the autoscore is complete. Third, given a resulting alpha point, it should be possible to find a rule set that generated that point. Fourth, a relational DBMS can store, retrieve and maintain connections between the various data item far more efficiently that the Graph Utility itself with such a large amount of data. Fifth, storing the data in a DBMS makes debugging far easier.

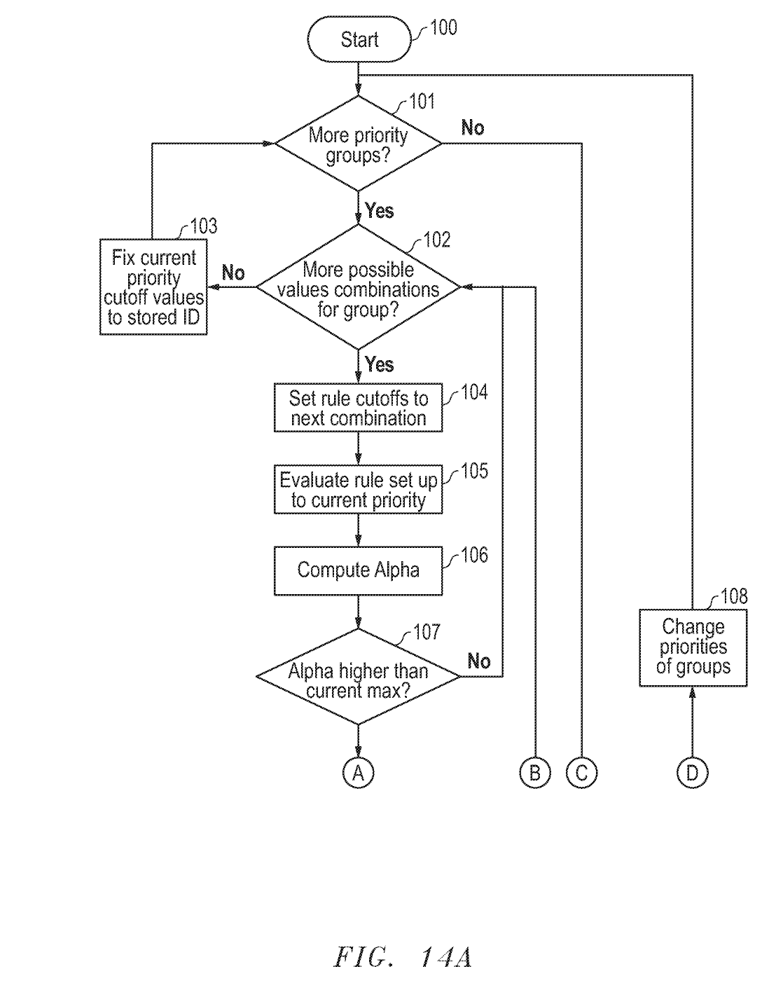

Referring now to FIG. 13, in the Rules Table, the source is a unique identifier for each of the possible rule criteria. The direction field indicates what classification is applied to this rule (DI or NDI). The Rule_ID field is a unique identifier assigned to each rule. Because it also identifies each unique row in the table, it is used as the primary key. This is used primarily for linking the source and direction fields with the other data tables.

The Rules_Set table stores all possible priority groupings for the specified rule set. The Rule_ID field identifies the rule from the Rules table a particular entry relates to. Because the Rule_ID field is used to link to entries in another table, it is identified as a foreign key. The priority field identifies the priority assigned to this rule. Note that within a single rule set, several rules may have the same priority. The Set_ID field is a unique identifier for a given set of priorities. Because of the large number of priority combinations, this value is stored as a bigint (64-bit) data type. Each Rule_ID can have multiple priorities in this table. All priorities with the same Set_ID value belong to a single rule set. In other words, each Set_ID value will appear once for each Rule_ID. Thus, both the Set_ID and Rule_ID values are used as a primary key for this table. By default, only the priority grouping of the base rule set is used, so a Set_ID of only one exists.

The Rule_Cutoff table stores all possible values for each rule, given the base rule set and the actual data values. As with the Rule_Set table, the Rule_ID field identifies the rule from the Rules table that an entry applies to. Again, the Rule_ID field here is used as a foreign key. The Cutoff val field indentifies which value is assigned to the specified rule for a given rule set. The Combo_ID field identifies which rule set a group of cutoff values belongs to. Again, as with the Rule_Set table, both the Combo_ID and Rule_ID values are used as a primary key, and each Combo_ID will appear once for each Rule_ID. Also, because of the potentially large number of cutoff value combinations, the Combo_ID is stored as a bigint (64-bit) data type.

The tables described above are all filled in the first stage of the general autoscore process, based on the user's input. Doing so allows the rule evaluation to run more efficiently.

The Points table stores the results of evaluating each rule set (a priority grouping with a specific set of cutoff values for each rule). The Combo_ID and Set_ID fields link to the Rule_Cutoff and Rule_Set tables, respectively, and are therefore foreign key values. They are also primary key values because each pair of (Combo_ID, Set_ID) values uniquely identifies a row in the Points table. The remaining fields identify the points on the alpha graph that are generated based on the indicated rule set. While the true values are computed as doubles, they are multiplied by a factor of 10000 so they can be stored as 16-bit integers rather than an 8-byte double-precision value, since storage space is an issue. The size of the database can easily reach into several gigabytes, depending on the input. The X field represents the percentage of sessions that remain inconclusive after evaluating the specified rule set. The Y_Total, Y_DI, and Y_DNI fields represent the ratio of correct calls to total calls resulting from evaluating the specified rule set. Y_Total takes the correct and incorrect calls for both DI and NDI sessions. Y_DI considers both the incorrect DI and NDI calls, but only the correct DI calls. Y_DNI considers both the incorrect DI and NDI calls, but only the correct NDI calls. The alpha field stores the total alpha value for the specified rule set and is currently stored as a double (8-bytes). However, in the future this will be multiplied by a factor of 10000 and stored as a 16-bit integer, as are the other point values.

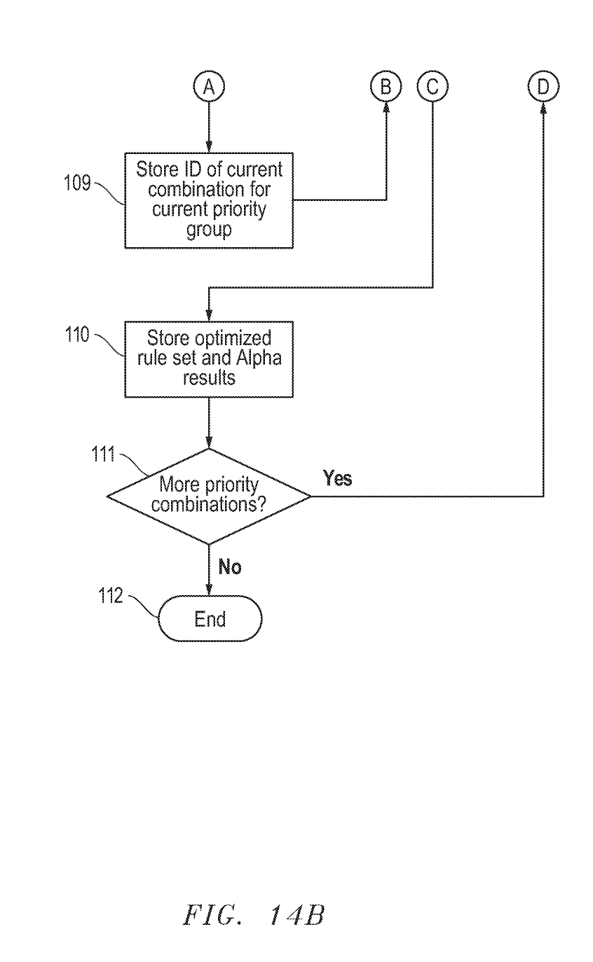

Referring now to FIGS. 14A and 14B, progressive autoscore is an optimization of general autoscore that finds the lie detection rule set that generates the highest general white alpha score for each possible priority order. The purpose of progressive autoscore is improved speed by reducing the number of rules that would have been considered in full general autoscore. The progressive autoscore algorithm determines the rule set with the best alpha value, given a base set of rule criteria groupings. The algorithm first determines the first cutoff values that generate the highest alpha for the first priority group. Then this group is fixed, and the next priority group is optimized in the same manner. This procedure is repeated for each priority group until an optimal rule set is determined for the specified priority group. The priority groups are then shifted such that the order changes, but the groups remain the same. The above algorithm is then repeated for this and all remaining priority combinations.

The following listing shows the pseudo-code for the algorithm shown in FIGS. 14A and 14B:

```
For each priority set:
  For each priority grouping in the set:
    Max_alpha = 0
    max_cutoff[ ] = null
    For each cutoff combination in group:
      For each rule in priority group:
        Rule.Value = current_cutoff[rule_id]
      DI_calls, NDI_calls =
        ScoreRules(rules[priority_0:priority_current])
      Alpha_current = GetAlpha(DI_calls, NDI_calls, RealData)
      If(Alpha_current > max_alpha)
        Max_alpha = = Alpha_current
        Max_cutoff[ ] = rule values up to this priority
      For each rule in priority group:
        Rule = max_cutoff[rule_id]
    DI_max, NDI_max = ScoreRules(rules)
    Alpha_results_max =
    GetAlphaResults(DI_max, NDI_max, RealData)
    WriteToDB(rules, alpha_results_max)
```

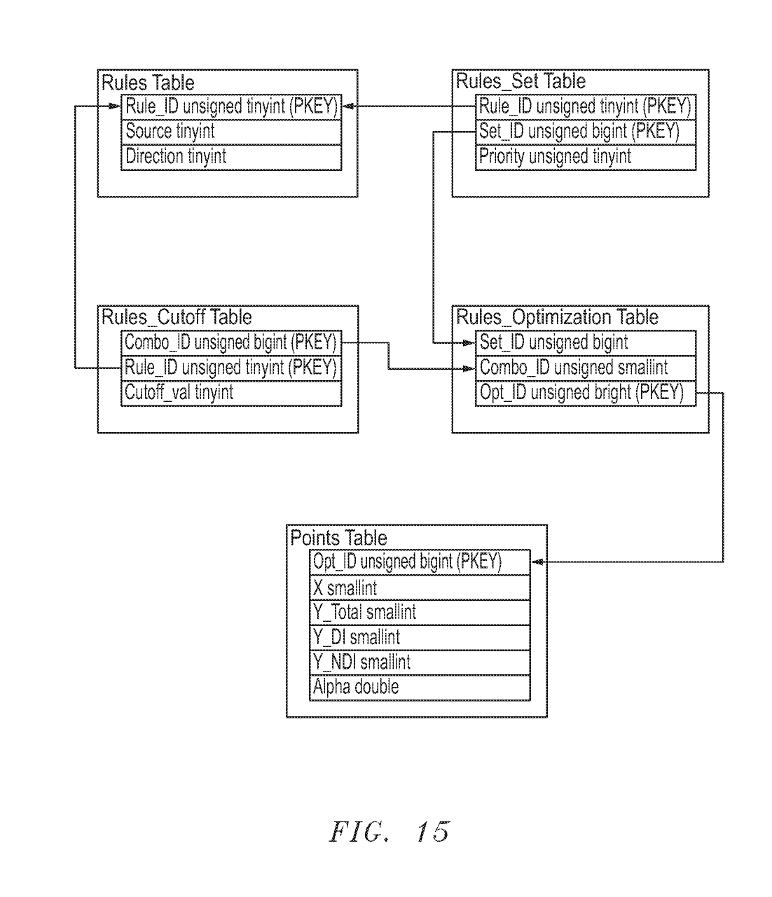

Referring now to FIG. 15, as with the general autoscore algorithm, the results of the progressive autoscore algorithm are stored in a MySQL database. The schema is similar to the one shown in FIG. 13, with a few minor changes. The Rules Table, Rule_Set Table, and Rule_Cutoff Table have the same schema for both progressive and general autoscore. However, the Combo_ID field in Rule_Cutoff has a slightly different meaning. In general autoscore, it uniquely identifies a set of cutoff values for an entire rule set. In progressive autoscore, it uniquely identifies a set of cutoff values for only those rules in the same priority group. There is no need to store every possible combination of values for an entire set, because not all of these combinations will be tested. However, all combinations for each priority will be tested, so only these values are stored.

The Rule_Optimization Table is an additional table for progressive autoscore. Because a given rule set can now have multiple Combo_ID fields, the Opt_ID field is used to define a single unique identifier for the optimal rule set with a given priority ordering. The Set_ID field links with the Rule_Set table.

The Points Table is similar to the Points Table in the general autoscore, with one minor difference. Only the Opt_ID field is needed to identify the rule set corresponding to a point. The remaining fields are the same as in the general autoscore Points Table.

1. A method for selecting the most accurate lie detection method from a group of methods, the method comprising the steps of:
(a) collecting the results from different methods of conducting lie detection tests,
(b) plotting the results on a polar graph;
(c) computing the “random chance” point on the graph for each method's results;
(d) fitting a quadratic curve to the defined points for each method;
(e) computing the area beneath each method's curve;
(f) mapping the area to a log-base-2 score; and
(g) choosing as the most accurate method the method with a higher log-base-2 score.

2. The method of claim 1, wherein the step of plotting uses a scatter plot.

3. A method for optimizing an existing lie detection method's internal decision rules to produce the most accurate results from conducting lie detection examinations, the optimization method comprising the steps of:
(a) collecting the results from using various different internal decision rule sets;
(b) plotting the results on a polar graph;
(c) computing the “random chance” point on the graph for each set's results;
(d) fitting a quadratic curve to the defined points for each method;
(e) computing the area beneath each set's curve;
(f) mapping the area to a log-base-2 score; and
(g) choosing as the most accurate internal decision rules the set of rules with a higher log-base-2 score.

4. A method for optimizing lie detection rule settings for a given lie detection methodology on populations with extreme population mixes, the optimization method comprising the steps of:
(a) collecting the results from using various different internal decision rule settings;
(b) plotting the results on a polar graph;
(c) computing the “random chance” point on the graph for each rule setting's results;
(d) fitting a quadratic curve to the defined points for each rule setting;
(e) computing the area beneath each rule setting's curve;
(f) mapping the area to a log-base-2 score; and
(g) choosing as the most accurate internal decision rules the set of rules with a higher log-base-2 score.

5. A method for optimizing early cancer diagnosis when multiple medical tests are present for a particular patient, and when a study has been done with similar patients containing the same tests on a past known population of patients, the optimization method comprising the steps of:
(a) collecting the results from the different cancer detection tests;
(b) plotting the results on a polar graph;
(c) computing the “random chance” point on the graph for each test's results;
(d) fitting a quadratic curve to the defined points for each test;
(e) computing the area beneath each test's curve;
(f) mapping the area to a log-base-2 score; and
(g) choosing as the most accurate cancer detection test the test with a higher log-base-2 score.
